(19) United States
(12) Patent Application Publication
(10) Pub. No.: US 2016/0326694 A1
(43) Pub. Date: Nov. 10, 2016

(54) HYDROGEN PEROXIDE COMPOSITIONS FOR THE DELIGNIFICATION OF PLANT MATTER, AND USES THEREOF

(71) Applicant: ARKEMA FRANCE, Colombes (FR)

(72) Inventors: Jérôme BLANC, Brignais (FR); Markus BRANDHORST, Lyon (FR)

(73) Assignee: Arkema France, Colombes (FR)

(21) Appl. No.: 15/110,277

(22) PCT Filed: Jan. 9, 2015
(86) PCT No.: PCT/FR2015/050044

§ 371 Date: Jul. 7, 2016

(30) Foreign Application Priority Data
Jan. 10, 2014 (FR) 1450200

(51) Int. Cl. D21C 9/16; D21C 3/04; C01B 15/037

(52) U.S. Cl. CPC D21C 9/163; C01B 15/037; D21C 3/04

(57) ABSTRACT

A system for the delignification of plant matter impregnated with a solution of organic acid selected from acetic acid, formic acid, propionic acid, butanoic acid, or a mixture of said acids, containing said plant matter and a hydrogen peroxide composition including hydrogen peroxide and at least one phosphorus-bearing additive, the phosphorus content in the composition being higher than, or equal to, 40 ppm, expressed in weight of elemental phosphorus in relation to the total weight of the composition, for the delignification of plant matter impregnated with a solution of organic acid, said plant matter being selected from straw and/or wood or a lignocellulosic paste originating from straw and/or wood, the mass ratio of the organic acid solution, expressed in weight of solution, to the plant matter, expressed in weight of dry matter, being between 1.5:1 and 10:1.

### FIELD OF THE INVENTION

The present invention relates to the field of delignifying plant matter. The invention relates especially to a first hydrogen peroxide composition for delignifying plant matter, to the use of such a composition for delignifying plant matter, and also to the use of a second hydrogen peroxide composition for delignifying plant matter. The invention also relates to the delignified plant matter thus obtained for the production of paper, glucose, ethanol, xylitol, organic acids, aliphatic diacids or monomers for the purpose of manufacturing various polymers.

According to certain embodiments, the invention more particularly falls within the field of manufacturing and optionally bleaching paper pulp.

### TECHNICAL BACKGROUND

Plant matter is mainly constituted of cellulose, hemicelluloses and lignins.

The delignification of plant matter is a process that consists in extracting and/or removing the lignins that this plant matter contains.

For the purposes of the present invention, the term “plant matter” will denote wood and/or straw or a lignocellulose pulp obtained from wood and/or straw.

The term “wood” means all the strong secondary tissues (for support, conduction and storage) that form the trunks, branches and roots of ligneous plants, as defined in standard NF B 50-003.

The term “straw” means annual plants, in other words plants which have a life cycle lasting about one year. When such plants are cultivated, one or more annual harvests may of course be made. Mention may be made in this respect of cereal plants such as rice, wheat, barley, corn, panics, or alternatively grasses, hemp, flax, sorghum, sugarcane, reed, miscanthus, etc.

The term “lignocellulose pulp” means a pulp containing cellulose, hemicelluloses and residual lignins, obtained following one or more steps of chemical and/or mechanical refining of straw or wood. Chemical refining is a chemical treatment directed toward removing the lignin present in straw or wood. Mechanical refining is a mechanical treatment directed toward individualizing cellulose fibers. In other words, the invention may also be performed on a predelignified pulp, to complete the delignification.

Usually, paper pulp is manufactured from wood. The processes for manufacturing paper pulp using wood as starting material pose several ecological problems. A first problem arises from the fact that wood is an exhaustible and fragile natural resource, and that increasing consumption of paper manufactured from wood risks further worsening the practice of deforestation. Another problem arises from the paper pulp manufacturing processes themselves, which use chemical compounds such as chlorinated products (chlorine gas, chlorine dioxide), which generate discharges that are toxic to the environment.

Sustained efforts have been made by researchers in recent years to find an alternative to the use of wood and/or to the use of harmful compounds in paper pulp manufacturing processes.

Thus, novel processes have come to light, which have the advantage of using straw as starting material and as a result make it possible to upgrade agricultural waste.

For example, the article “Organic Acid Pulping of Rice Straw. I: Cooking” by Jahan et al., published in 2006 in Turk. J. Agric. For. 30, pages 231-239, is known, which is a two-step process for delignifying rice straw. The first step comprises treating rice straw with acetic acid or formic acid in the presence of a catalyst (HCI or H₂SO₄) at a temperature below 100° C. The second step is either an alkaline extraction or a peroxy acid treatment. The latter treatment comprises placing the pulp obtained from the first step in contact with hydrogen peroxide and fresh acetic acid or formic acid to form the peracid corresponding to the organic acid used in the first step.

Patent application WO 99/57364 moreover discloses a process for manufacturing paper pulp that can be used as raw material for herbaceous plants, using a mixture of formic acid and acetic acid as chemical cooking agent. A step of bleaching the paper pulp obtained may be performed using a hydrogen peroxide.

Patent application WO 98/20198 also discloses a process for manufacturing paper pulp by performing: defibering of raw material by cooking with formic acid performed in a single operation; removal of the cooking liquor and washing of the pulp with formic acid: at the end of this washing, performic acid, obtained by adding hydrogen peroxide to formic acid optionally with other peracids, is added to the pulp, which is free of cooking liquor and of medium or high consistency; removal of the acid(s) still present in the pulp; bleaching of the pulp.

Patent application WO 02/22945 describes a process for bleaching paper pulp, especially comprising placing the raw pulp in contact with a mixture of peracetic acid and performic acid, enabling degradation of the residual lignins present.

However, there is still a need to improve the delignification of plant matter relative to the processes mentioned previously.

There is in particular a need to improve the delignification efficiency, by obtaining a pulp with a higher degree of delignification, and/or by consuming less hydrogen peroxide to delignify the pulp.

### SUMMARY OF THE INVENTION

The present invention makes it possible to overcome the drawbacks of the prior art. This is accomplished by means of a hydrogen peroxide composition comprising hydrogen peroxide and at least one phosphorus additive, the phosphorus content in the composition being greater than or equal to 40 ppm, expressed by weight of elemental phosphorus relative to the total weight of the composition, for the delignification of plant matter impregnated with a solution of organic acid chosen from acetic acid, formic acid, propionic acid, butyric acid or a mixture of these acids, and preferably a mixture of acetic acid and formic acid, said plant matter being chosen from straw and/or wood or a lignocellulose pulp derived from straw and/or wood; the mass ratio of the organic acid solution, expressed as weight of solution, to the plant matter, expressed as weight of dry matter, being from 1.5:1 to 10:1, preferably from 4:1 to 10:1.

According to one embodiment of the invention, the phosphorus content in the hydrogen peroxide composition is greater than or equal to 45 ppm, preferably 50 ppm, preferably 54 ppm, or even 1000 ppm, expressed as weight of elemental phosphorus relative to the total weight of the composition.

According to one embodiment of the invention, the content of phosphorus additive(s) in the hydrogen peroxide composition ranges from 120 ppm to 50 000 ppm, or even from 130 ppm to 20 000 ppm, or even from 1000 ppm to 10 000 ppm, expressed as weight of phosphorus additives relative to the total weight of the composition.

According to one embodiment of the invention, the phosphorus additives(s) are chosen from: phosphoric acid, aminophosphonic acids, hydroxyphosphonic acids, diphosphoric acids, orthophosphoric acid, salts thereof and mixtures thereof.

According to one embodiment of the invention, the hydrogen peroxide composition comprises from 30% to 75%, for example from 30% to 71%, preferably from 49% to 60%, or even from 49% to 55%, by weight of hydrogen peroxide relative to the total weight of the composition.

According to one embodiment, the hydrogen peroxide composition is divided into at least two fractions, known as the “first and second fractions”, the hydrogen peroxide mass of the first fraction being strictly greater than the hydrogen peroxide mass of the second fraction. Surprisingly, placing the impregnated plant matter in contact with the at least two fractions consecutively makes it possible to further lower the lignin content in the delignified plant matter.

According to one embodiment of the invention, the hydrogen peroxide composition is used in a proportion of from 10 to 300 kg of hydrogen peroxide per tonne of impregnated plant matter and preferably from 30 to 200 kg of hydrogen peroxide per tonne of impregnated plant matter, expressed as weight of solids.

According to one embodiment of the invention, the composition according to the invention may also be used for bleaching said delignified plant matter.

The invention thus relates to a system for delignifying plant matter impregnated with a solution of organic acid chosen from acetic acid, formic acid, propionic acid, butyric acid, or a mixture of these acids, and preferably a mixture of acetic acid and formic acid, containing said plant matter and a hydrogen peroxide composition comprising at least one phosphorus additive, the phosphorus content of the composition being greater than or equal to 40 ppm, expressed as weight of elemental phosphorus relative to the total weight of the composition, for the delignification of plant matter impregnated with the abovementioned organic acid solution, said plant matter being chosen from straw and/or wood or a lignocellulose pulp derived from straw and/or wood and the mass ratio of the organic acid solution, expressed as weight of solution, to the plant matter, expressed as weight of solids, being from 1.5:1 to 10:1, preferably from 4:1 to 10:1.

The composition of this system for delignifying impregnated plant matter is that presented previously and subsequently in the rest of the description.

A subject of the invention is also the use of a phosphorus additive in a hydrogen peroxide composition for delignifying plant matter.

A subject of the invention is also the use of a hydrogen peroxide composition divided into at least two “fractions”, the hydrogen peroxide mass of the first fraction being strictly greater than the hydrogen peroxide mass of the second fraction, for delignifying plant matter impregnated with an organic acid solution, said plant matter being chosen from straw and/or wood or a lignocellulose pulp derived from straw and/or wood.

According to one embodiment of the invention, the organic acid is acetic acid, formic acid, propionic acid, butyric acid, or a mixture of these acids, preferably being a mixture of acetic acid and formic acid.

According to one embodiment of the invention, the mass ratio of the organic acid solution, expressed as weight of solution, to the plant matter, expressed as weight of solids, is from 1.5:1 to 10:1, preferably from 4:1 to 10:1.

According to one embodiment of the invention, the total amount of hydrogen peroxide introduced via said fractions is from 10 to 300 kg/tonne of impregnated plant matter, preferably from 30 to 200 kg/tonne of impregnated plant matter, or even from 50 to 200 kg/tonne of impregnated plant matter, expressed as weight of dry pulp.

According to one embodiment of the invention, the composition is divided into at least three fractions, known as the “first, second and third fractions”, the hydrogen peroxide mass of the first fraction being strictly greater than the respective hydrogen peroxide mass of the second and third fractions.

According to one embodiment of the invention, the composition is divided into at least three fractions of the hydrogen peroxide composition, known as the “first, second and third fractions”, the hydrogen peroxide mass of the second fraction being substantially equal to the hydrogen peroxide mass of the third fraction.

According to one embodiment of the invention, the hydrogen peroxide mass of the second fraction is substantially equal to the hydrogen peroxide mass of any other fraction of the hydrogen peroxide composition placed in contact with the impregnated plant matter subsequent to the second fraction.

According to one embodiment of the invention, the hydrogen peroxide mass of the first fraction is greater than or equal to 20% by weight, preferably 30% by weight, preferably 40% by weight, preferably 50% by weight, of the total hydrogen peroxide mass of the composition placed in contact with the impregnated plant matter.

According to one embodiment of the invention, each fraction of the hydrogen peroxide composition is placed in contact with the impregnated plant matter for a retention time during which the hydrogen peroxide composition is left to react with the impregnated plant matter, this retention time preferably being of substantially identical duration for the placing in contact of the impregnated plant matter with each fraction of the hydrogen peroxide composition except for with the last fraction.

According to one embodiment of the invention, the retention time after placing the impregnated plant matter in contact with the last fraction of the hydrogen peroxide composition has a duration strictly longer than any of the previous retention times.

According to one embodiment of the invention, the composition comprising hydrogen peroxide is constituted, as weight percentages relative to the total weight of the composition:

of 30% to 71% of hydrogen peroxide,

of 0 to 10% of one or more additives,

of the remainder to 100% of water.

Finally, a subject of the invention is also the use of the delignified pulp thus obtained for the production of paper, glucose, ethanol, xylitol, organic acids, aliphatic diacids or monomers intended, for example, for the production of polymers.

### DETAILED DESCRIPTION OF THE INVENTION

Unless otherwise indicated, the measurements and the use of the compositions according to the invention are performed at atmospheric pressure.

When reference is made to ranges, expressions of the type “ranging from . . . to . . .” include the limits of the range. Conversely, expressions of the type “between . . . and . . . ” exclude the limits of the range.

The term “dry” plant pulp or matter means the anhydrous mass of material of a sample of material in suspension as defined in standard ISO 4119, this mass being measured after filtering and drying in accordance with said standard.

The hydrogen peroxide mass in the hydrogen peroxide composition of the invention or in a fraction thereof may be measured via the method CEFIC-H2O2-AM-7157. This method consists in titrating the hydrogen peroxide in an aqueous sulfuric acid solution using a standard volumetric solution of potassium permanganate.

The phosphorus content in the hydrogen peroxide composition of the invention or in any aqueous hydrogen peroxide solution used for its preparation, generally expressed as weight of elemental phosphorus relative to the total weight of the composition or of the solution, may be measured by plasma torch spectrometry (optical ICP).

The invention will now be described in greater detail and in a non-limiting manner in the description that follows. The various embodiments described may advantageously be combined. They apply indiscriminantly to the hydrogen peroxide composition comprising at least one phosphorus additive, to the use of the hydrogen peroxide composition divided into at least two “fractions” or to the use of a phosphorus additive forming the subject of the invention.

As mentioned above, the present invention relates to the delignification of plant matter chosen from straw and/or wood or a lignocellulose pulp derived from straw and/or wood, which has been placed in contact with an organic acid solution, to obtain a plant matter pulp impregnated with said organic acid, referred to as “impregnated pulp” or “impregnated plant matter”.

When straw and/or wood is used as starting plant matter, it may be used entirely or partly, i.e. in its entirety or in the form of pieces, for example chips preferably ranging from 0.5 to 20 cm in size. Any milling means known to those skilled in the art may be used to shred the straw or wood.

When a lignocellulose pulp is used as starting plant matter, in other words a predelignified pulp within the meaning of the invention, the lignin content of this pulp may advantageously range from 1% to 10%, for example from 2% to 8%, or even from 2% to 5%, by weight of lignin relative to the weight of solids of the pulp.

This lignin content may be calculated by multiplying the kappa index of the pulp by a factor of 0.15. The kappa index of the pulp may be measured in accordance with standard ISO 302.

The consistency (solids content) of the lignocellulose pulp used, where appropriate, may advantageously range from 10% to 100%, for example from 50% to 100%, relative to the total weight of said pulp.

The use of straw or of a lignocellulose pulp derived from straw as starting plant matter is particularly advantageous since this resource is available in abundance and at reduced cost.

The organic acid solution used for the impregnation comprises one or more organic acids, preferentially one or more light organic acids, i.e. organic acids whose main chain is a linear or branched, saturated or unsaturated C₁-C₅ and preferably C₁-C₄ hydrocarbon-based chain, which is optionally substituted and optionally interrupted with one or more heteroatoms. As examples of organic acids that may be used in the present invention, mention may be made of acetic acid, formic acid, propionic acid, butyric acid, or a mixture of these acids, and even more preferably a mixture of acetic acid and formic acid.

The preferred acetic acid/formic acid mixture is that which corresponds to the azeotrope that may be distilled downstream to recycle these two acids.

When a mixture of formic acid and acetic acid is used, the formic acid/acetic acid mass ratio in the organic acid solution preferably ranges from 0.4 to 0.7 and even more preferably from 0.5 to 0.6.

The total content of organic acid(s) in said organic acid solution preferably ranges from 50% to 95% by weight, especially from 70% to 90% by weight and preferentially from 80% to 90% by weight, relative to the total weight of the solution.

The remainder to 100% by weight of the organic acid solution is generally provided by water, but the solution may optionally comprise one or more additives, insofar as these additives are not of a nature to modify the intrinsic properties of the solution.

According to an advantageous embodiment, the organic acid solution comprises (or even is constituted of), as weight percentages relative to 100% by weight of this solution:

25% to 35% by weight of formic acid,

50% to 60% by weight of acetic acid and

10% to 20% of water.

The mass ratio of the organic acid solution, expressed as weight of solution, to the plant matter to be treated, expressed as weight of solids, may advantageously be from 1.5:1 to 10:1 and preferably from 4:1 to 10:1.

Such compositions according to the invention may be used in processes also comprising a step of separating the solid phase, constituting said impregnated plant matter, from the liquid phase, especially containing the organic acid(s) used and also dissolved lignins and monomeric and polymeric sugars derived from the plant matter after impregnation of the plant matter. The separation may be performed via any technique known to those skilled in the art, for example by pressing.

The placing in contact of the plant matter with the organic acid solution may be repeated, for example twice. Repeated placing in contact may prove to be advantageous when the starting plant matter is straw and/or wood, so as to facilitate the subsequent delignification of the plant matter impregnated with organic acid.

The time of placing in contact of the plant matter with the organic acid solution may advantageously range from 2 to 5 hours, for example ranging from 3 to 4 hours.

The temperature of placing in contact of the plant matter with the organic acid solution may advantageously range from 70 to 130° C. and especially from 100 to 110° C.

The time of placing in contact and the temperature are advantageously correlated such that the organic acid solution dissolves the lignins and hydrolyses the hemicelluloses of the plant matter.

After impregnation, the lignin content of the plant matter impregnated with organic acid (calculated according to the method presented previously) may advantageously range from 1% to 10%, for example from 1% to 8%, or even from 2% to 5%, by weight of lignin relative to the weight of solids in the plant matter.

The consistency (solids content) of the impregnated plant matter thus obtained may advantageously range from 1% to 40%, for example from 10% to 15%, relative to the total weight of the plant matter.

Advantageously, the delignification is consecutive to the impregnation. This means that the organic acid solution and the hydrogen peroxide composition are not premixed placed in contact with the plant matter. This makes it possible to obtain good delignification of the plant matter pulp manufactured, while at the same time limiting the risks of explosion associated with the formation of peracids for the delignification.

The term “phosphorus additive” means an organic or mineral molecule containing at least one and preferably at least two phosphorus atoms.

The phosphorus content in the hydrogen peroxide composition comprising the phosphorus additive may advantageously be greater than or equal to 45 ppm, for example 50 ppm, especially 54 ppm, or even 1000 ppm, expressed as weight of elemental phosphorus relative to the total weight of the composition.

The content of elemental phosphorus in the hydrogen peroxide composition comprising the phosphorus additive is preferably less than or equal to 20 000 ppm, or even 10 000 ppm, or even 5000 ppm, expressed as weight of elemental phosphorus relative to the total weight of the composition. This makes it possible to obtain a good compromise between the efficacy and the cost of the composition.

According to an advantageous embodiment, the phosphorus additives(s) present in the hydrogen peroxide composition are chosen from: phosphoric acid, aminophosphonic acids, hydroxyphosphonic acids, diphosphoric acids, orthophosphoric acid, salts thereof and mixtures thereof. Mention may be made more particularly of phosphoric acid, 1-hydroxyethylene-1,1-diphosphonic acid, aminotris-methylenephosphonic acid, ethylenediaminetetra(methylenephosphonic) acid, diethylenetriaminepenta(methylenephosphonic) acid, hexamethylenediaminetetra(methylenephosphonic) acid, salts thereof and mixtures thereof.

According to one embodiment, the phosphorus additive(s) do not comprise a primary, secondary or tertiary amine function. Examples that may be mentioned include phosphoric acid and 1-hydroxyethylene-1,1-diphosphonic acid, salts thereof and mixtures thereof.

The content of phosphorus additive(s) in the hydrogen peroxide composition may advantageously range from 120 ppm to 50 000 ppm, or even from 130 ppm to 20 000 ppm, or even from 1000 ppm to 10 000 ppm, expressed as weight of phosphorus additive(s) relative to the total weight of the composition.

The phosphorus additive(s) may be used directly or, for example, in the form of an aqueous solution.

The hydrogen peroxide composition may also comprise one or more non-phosphorus additives insofar as their presence does not modify the behavior of the composition in delignification, which additives may be chosen, for example, from the usual hydrogen peroxide stabilizers. Examples that may be mentioned include sodium stannate, succinic acid, adipic acid, citric acid, EDTA, diethylenetriaminepentaacetic acid (DTPA), or any other chelating agent conventionally used for bleaching a paper pulp.

The content of non-phosphorus additives potentially present in the hydrogen peroxide composition may range from 0 to 5% and preferably from 0 to 500 ppm, expressed as weight of non-phosphorus additives relative to the total weight of the composition.

According to a particular embodiment of the invention, the presence of alkali metal or alkaline-earth metal stannates in the hydrogen peroxide composition is tolerated in a proportion of from 0 to 500 ppm and preferably from 0 to 100 ppm, expressed as weight of stannates relative to the total weight of the composition.

The hydrogen peroxide compositions according to the invention may advantageously comprise from 30% to 75%, for example from 30% to 71%, especially from 40% to 71%, from 49% to 60%, for example from 49% to 55% by weight of hydrogen peroxide relative to the total weight of the composition.

The remainder to 100% by weight of the hydrogen peroxide composition, relative to the sum of the weight percentages of hydrogen peroxide, and of possible phosphorus additives and non-phosphorus additives that it contains, is generally provided by water.

Any hydrogen peroxide composition according to the invention may be prepared via any method known to those skilled in the art. It is possible, for example, to start with an aqueous hydrogen peroxide solution to which is added, advantageously with stirring, the optional phosphorus additives and non-phosphorus additives. Said additives may be added directly or in the form of an aqueous solution, for example obtained by diluting said additives in water. The hydrogen peroxide composition formed may be homogenized via any means known to those skilled in the art, for example by mechanical stirring or injection of air.

The starting aqueous hydrogen peroxide solution, i.e. the solution without said phosphorus or non-phosphorus additives, may be manufactured via any process known to those skilled in the art, for example via the anthraquinone process. Reference may be made in this respect to Ullman's Encyclopedia of Industrial Chemistry, fifth edition, volume A 13, pages 446-461.

The starting aqueous hydrogen peroxide solution may, where appropriate, be purified before being used to prepare the hydrogen peroxide composition of the invention. Any technique known to those skilled in the art may be used for this purpose, for example distillation, an anionic or cationic ion-exchange resin, an adsorption resin or reverse osmosis.

The phosphorus content of the starting aqueous hydrogen peroxide solution is generally less than or equal to 30 ppm, or even 15 ppm, or even 10 ppm, expressed as weight of elemental phosphorus relative to the total weight of the solution.

Any hydrogen peroxide composition according to the invention may advantageously be used in proportions such that the weight of hydrogen peroxide relative to the weight of impregnated plant matter (expressed as weight of dry pulp) ranges from 10 to 300 kg of hydrogen peroxide per tonne of impregnated plant matter, for example from 30 to 200 kg of hydrogen peroxide per tonne of impregnated plant matter, or even from 50 to 200 kg of hydrogen peroxide per tonne of impregnated plant matter.

After placing the impregnated plant matter in contact with the hydrogen peroxide composition, the pulp may be left to react for a certain time known as the “retention time”.

This retention time is preferably sufficient to reach a maximum concentration of peracids in the reaction medium (medium formed by the impregnated plant matter and the hydrogen peroxide composition).

The concentration of peracids in the reaction medium at a given moment may be determined via any technique known to those skilled in the art, for example by titration using a standard volumetric solution of sodium thiosulfate. The following protocol may be performed. The reaction medium is filtered through a Büchner funnel to separate the pulp from the liquid phase. 20 g of this liquid phase are taken and placed in a conical flask containing 100 mL of cold water, 10 mL of sulfuric acid at 2 mol.L⁻¹, 10 mL of potassium iodide and a few drops of colored indicator (commercial reference Iotect® from VWR). The solution obtained is assayed with sodium thiosulfate solution at 0.05 mol.L⁻¹. The color change determines the mass of peracids in the solution.

The retention time during which the pulp is left to react with the hydrogen peroxide composition, when the composition is not divided into fractions, may advantageously range from 20 to 180 minutes, for example from 40 to 120 minutes and preferably from 80 to 100 minutes.

As mentioned above, the invention also relates to a hydrogen peroxide composition divided into at least two “fractions”, the hydrogen peroxide mass of the first fraction being strictly greater than the hydrogen peroxide mass of the second fraction, for delignifying plant matter impregnated with an organic acid solution, said plant matter being chosen from straw and/or wood or a lignocellulose pulp derived from straw and/or wood, and to its use for delignifying plant matter. Such a composition may advantageously comprise at least one phosphorus additive, the phosphorus content in the composition being greater than or equal to 40 ppm, expressed as weight of elemental phosphorus, relative to the total weight of the composition.

The inventors have thus discovered, unexpectedly, that placing the plant matter impregnated with organic acid in contact with the hydrogen peroxide in fractional manner, taking care to add a larger amount of hydrogen peroxide to the plant matter during the first addition, makes it possible to increase the degree of delignification of the pulp and/or to reduce the amount of hydrogen peroxide to be used, relative to a delignification performed without fractioning and/or without using a larger amount of hydrogen peroxide during the first addition.

The placing in contact of the hydrogen peroxide composition with the impregnated plant matter may be fractional, such that the number of fractions of hydrogen peroxide composition consecutively placed in contact with the impregnated pulp is greater than or equal to 2, or even 3, 4, 5 or even 6. The corresponding fraction will be denoted by the first, second, where appropriate third, fourth . . . sixth, fraction, etc.

The hydrogen peroxide mass of the first fraction may advantageously be greater than or equal to 20% by weight, preferably 30% by weight, preferably 40% by weight, preferably 50% by weight, of the total mass of hydrogen peroxide contained in the hydrogen peroxide composition used for the delignification.

It will be noted that the total mass of hydrogen peroxide of the hydrogen peroxide composition is equivalent to the sum of the respective hydrogen peroxide masses of the various fractions of the hydrogen peroxide composition that are placed in contact with the impregnated plant matter.

When the hydrogen peroxide composition is divided into at least three fractions, it is advantageous for the hydrogen peroxide mass of the first fraction to be strictly greater than the hydrogen peroxide mass of the second and third fractions, respectively. It will be noted that the hydrogen peroxide mass of the first fraction is expressed relative to the hydrogen peroxide mass of the second fraction considered in isolation and, similarly, relative to the hydrogen peroxide mass of the third fraction.

More generally, it is advantageous for the hydrogen peroxide mass of the first fraction to be strictly greater than the hydrogen peroxide mass of any other fraction of hydrogen peroxide composition that is placed in contact with the impregnated pulp subsequent to the first fraction.

When the hydrogen peroxide composition is divided into at least three fractions, it is more advantageous for the hydrogen peroxide mass of the second fraction to be substantially equal to the hydrogen peroxide mass of the third fraction.

More generally, it is advantageous for the hydrogen peroxide mass of the second fraction to be substantially equal to the hydrogen peroxide mass of any other fraction of hydrogen peroxide composition that is placed in contact with the impregnated pulp subsequent to the second fraction.

The term “substantially equal” mass means that a difference between the respective hydrogen peroxide masses of the fractions under consideration is tolerated, insofar as this difference does not lessen the final degree of delignification of the pulp. In particular, a relative difference of ±10% by weight between the respective hydrogen peroxide masses of the fractions under consideration is acceptable.

After adding a fraction of hydrogen peroxide composition, it is advantageous to leave the hydrogen peroxide composition to react with the impregnated pulp for a certain time, known as the “retention time”.

The retention time after each fraction of composition added is preferably sufficient to reach a maximum concentration of peracids in the reaction medium (medium formed by the impregnated pulp and the hydrogen peroxide composition).

The retention time of the pulp after adding a fraction of composition may range, for example, from 5 to 25 minutes, in particular from 13 to 22 minutes and preferably from 14 to 16 minutes.

According to an advantageous embodiment, the retention time of the pulp is of substantially identical duration after each fraction added except for the last one. Specifically, it is preferred for the retention time consecutive to the addition of the last fraction of hydrogen peroxide composition to be of a duration strictly longer than any of the preceding retention times (i.e. at the very least longer than the retention time consecutive to the first fraction). This embodiment makes it possible to achieve substantial saving in hydrogen peroxide for the delignification of the pulp.

The retention time consecutive to the addition of the last fraction of hydrogen peroxide composition may range, for example, from 15 to 40 minutes, especially from 24 to 36 minutes and preferably from 28 to 32 minutes.

The sum of the retention times during which the pulp is left to react with the hydrogen peroxide composition may advantageously range from 20 to 180 minutes, for example from 40 to 120 minutes and preferably from 80 to 100 minutes.

The total content of hydrogen peroxide added to the impregnated plant matter by means of the various fractions of composition may advantageously range from 10 to 300 kg/tonne of impregnated pulp, preferably from 30 to 200 kg/tonne of impregnated pulp, or even from 50 to 200 kg/tonne of impregnated pulp, expressed as weight of dry pulp.

The hydrogen peroxide composition may optionally comprise one or more additives, insofar as these additives do not modify the intrinsic properties of the composition.

These additives are chosen, for example, from the usual hydrogen peroxide stabilizers, especially from: quinoline; hydroxyquinoline and salts thereof; phosphoric acid and salts thereof, especially the sodium salt; tin oxides such as tin stannate; carboxylic acids such as salicylic acid, dipicolinic acid, citric acid, benzoic acid; sodium hydrogen pyrophosphate; organic phosphonic acids and salts thereof, especially the sodium salt; sodium nitrate, sodium silicate, sodium borate, organic stabilizers such as acetanilide; and mixtures thereof.

The content of additives potentially present in the hydrogen peroxide composition may range, for example, from 0 to 10%, from 0.001% to 10%, especially from 0.001% to 5%, from 0.01% to 5% and more particularly from 0.1% to 1% of the total weight of the composition.

For example, the hydrogen peroxide composition used for the delignification is constituted of, as weight percentages relative to the total weight of the composition:

from 30% to 71% of hydrogen peroxide,

from 0 to 10% of one or more additives,

the remainder to 100% of water.

The temperature at which the compositions according to the invention are used by placing the impregnated plant material in contact with the hydrogen peroxide composition may advantageously range from 40 to 100° C., preferably from 60 to 90° C. and more preferentially from 70° C. to 85° C. This temperature may advantageously be maintained throughout the period of placing in contact. The same temperature is preferably maintained for the placing in contact of the impregnated pulp with the second fraction of composition and, where appropriate, with the consecutive fraction(s).

Washing of the pulp between two additions of composition for the delignification is not required.

The consistency (solids content) of the delignified plant matter pulp obtained may advantageously range from 1% to 30%, for example from 10% to 15%, relative to the total weight of said pulp.

The lignin content (calculated according to the method presented above) of the delignified plant matter pulp obtained may advantageously range from 0.2% to 8%, for example from 0.2% to 6%, or even from 0.2% to 4%, by weight of lignin relative to the solids content of the pulp.

The compositions according to the invention may also be used for the delignification of impregnated plant matter placed in contact with at least one neutralizer after delignification. The neutralizer may be, for example, liquid water or steam.

The compositions according to the invention may also be used for the delignification of impregnated plant matter placed in contact with at least one bleaching agent, after delignification or after placing in contact with at least one neutralizer. The bleaching agent is chosen, for example, from ozone, chlorine and hydrogen peroxide. It is preferentially hydrogen peroxide to avoid the use of environmentally harmful chemical products. The total content of bleaching agent used preferably ranges from 0.1% to 50% by weight relative to the weight of the pulp, expressed as weight of dry pulp.

The compositions according to the invention may also be used for the delignification of impregnated plant matter placed in contact with at least one washing agent after impregnating the plant matter with the organic acid solution, and/or after delignifying the impregnated plant matter, and/or after placing the delignified plant matter in contact with at least one neutralizer and/or bleaching agent.

Washing agents that may be mentioned include water, an organic acid or a mixture of organic acids. This organic acid or mixture of organic acids is preferably the same as that used for the impregnation of the plant matter to be delignified. In the case of a mixture of acids, the same relative proportions as those of the acids used for the impregnation of the plant matter to be delignified may advantageously be conserved.

The placing in contact with at least one washing agent may be performed, for example, on the impregnated plant matter. This washing makes it possible especially to remove the possible traces of lignins and sugars still present in the plant matter. It is advantageous to use as washing agent one or more organic acids, which are preferably identical to those used for the impregnation of the plant matter to be delignified and ideally in the same proportions. More preferably, the organic acid(s) are used in pure form.

According to one embodiment, the compositions according to the invention are used for the delignification of an impregnated plant matter that has not been washed with water after impregnation, so as not to lessen the reaction of the hydrogen peroxide with the organic acid(s) during the delignification.

The placing in contact with at least one washing agent may also be performed on the delignified and/or bleached plant matter. When the placing in contact with at least one washing agent is performed on the delignified plant matter, the washing agent may advantageously be chosen from water or one or more organic acids. When the placing in contact with at least one washing agent is performed on the bleached plant matter, water is preferred as washing agent.

The placing in contact with at least one washing agent may be repeated, for example twice.

According to another embodiment, the organic acid(s) used for the impregnation of the plant matter and/or, where appropriate, the washing agent(s) used may be recovered and purified in order to be reused. This treatment makes it possible to remove the sugars and the lignin fragments derived from the plant matter which are contained in the organic acid solution used for the impregnation of the plant matter. Any technique known to those skilled in the art may be performed for this purpose, for instance vacuum evaporation or distillation.

### EXAMPLES

The examples that follow illustrate the invention without limiting it.

### Preparation of a Lignocellulose Pulp Used in the Examples

Air-dried wheat straw is placed in contact with a mixture of acetic acid, formic acid and water for 3 hours 30 minutes at 105° C. and at atmospheric pressure, in the following proportions: 105.3 g of straw containing 95% humidity (i.e. 100 g of solids), 385 g of pure acetic acid, 210 g of pure formic acid and 99.7 g of water. On conclusion of this operation, the liquid phase of the pulp is separated out so as to keep a pulp with a dryness ranging from 20% to 45% (i.e. a solids content ranging from 20% to 45% by weight relative to the total weight of the pulp).

### Example 1

### Hydrogen Peroxide Compositions Used in the Various Tests of Example 1

Test 1: a commercial aqueous hydrogen peroxide solution constituted of 59% by weight of hydrogen peroxide and the remainder to 100% of water is used. The phosphorus content in the solution is strictly less than 5 ppm by weight relative to the total weight of the solution as measured by plasma torch spectrometry (optical ICP).

Test 2: a hydrogen peroxide solution identical to that of Test 1 is used, except that citric acid is added thereto in a proportion of 2000 ppm by weight relative to the total weight of the solution.

Test 3: an aqueous hydrogen peroxide solution comprising 49% by weight of hydrogen peroxide and 130 ppm of a phosphorus additive in accordance with the invention, expressed as weight of phosphorus additive relative to the total weight of the solution, is used. The phosphorus content in the solution is equal to 55 ppm by weight relative to the total weight of the solution as measured by plasma torch spectrometry (optical ICP).

Test 4: an aqueous hydrogen peroxide solution comprising 69% by weight of hydrogen peroxide and 8130 ppm of a mixture of phosphorus additives in accordance with the invention, expressed as weight of phosphorus additives relative to the total weight of the solution, is used. The phosphorus content in the solution is equal to 2743 ppm by weight relative to the total weight of the solution as measured by plasma torch spectrometry (optical ICP).

A lignocellulose pulp containing 25% dryness prepared according to the protocol described above, with a kappa index equal to 25, measured according to standard ISO 302, is used. It is recalled that the kappa index of the pulp reflects the amount of lignin remaining in the pulp. The lower this index, the better the delignification.

120 g of the lignocellulose pulp are placed in contact at room temperature (20° C.) with a composition containing 36 g of pure formic acid, 66 g of pure acetic acid and 18 g of distilled water, in a sealed plastic bag. Manual shaking is performed for 2 minutes.

For each test, the pulp obtained is placed in contact at a temperature of 80° C. with the corresponding hydrogen peroxide composition prepared as indicated above, in an amount equivalent to 120 kg H₂O₂/tonne of dry pulp (i.e. per tonne of solids in the pulp). The mixture is left to react for 90 minutes. The pulp is drained and separated by pressing and then washed a first time with pure acetic acid and a second time with water. The kappa index of the pulp obtained is measured according to standard ISO 302. The results are given in Table 1.

TABLE 1

| | Test 1 | | | |
|---|---|---|---|---|
| | (compar- | Test 2 | Test 3 | Test 4 |
| | ative) | (comparative) | (invention) | (invention) |
| H₂O₂ | No | 2000 ppm of | phosphorus | mixture of |
| composition | additive | citric acid | additive | phosphorus |
| | | | | additives |
| Phosphorus | 0 | 0 | 55 ppm | 2743 ppm |
| as weight of | | | | |
| elemental | | | | |
| P/total | | | | |
| weight of | | | | |
| the H₂O₂ | | | | |
| composition | | | | |
| Kappa index | 11.3 | 11.3 | 10.9 | 10.7 |
| after | | | | |
| delignification | | | | |

It is found that a hydrogen peroxide composition containing a non-phosphorus additive such as citric acid has no beneficial effect in terms of delignification (same final kappa index value for Tests 1 and 2).

On the other hand, in accordance with the invention, the use of hydrogen peroxide compositions comprising one or more phosphorus additives to delignify a lignocellulose pulp makes it possible to significantly increase the degree of delignification of the final pulps obtained (Tests 3 and 4).

### Example 2

The products used are as follows:

commercial aqueous hydrogen peroxide solution at 49.5% by weight of H₂O₂ relative to its total weight, as measured by the method CEFIC H2O2-AM-7157;

acetic acid (100% Analar Normapur acetic acid, VWR Prolabo);

formic acid (298% formic acid, Riedel de Haen, Sigma-Aldrich).

### Series 1

A lignocellulose pulp prepared as above, containing 40% dryness, with a kappa index equal to 28, measured according to standard ISO 302, is used. It is recalled that the kappa index of the pulp reflects the amount of lignin remaining in the pulp. The lower this index, the more the pulp is delignified.

### Example 2.1.1 (In Accordance With the Invention)

75 g of the lignocellulose pulp are placed in contact at room temperature (20° C.) with a solution containing 49.50 g of pure formic acid, 90.75 g of pure acetic acid and 24.75 g of distilled water, in a plastic bag, which is then sealed. Manual shaking (blending) is performed for 2 minutes.

The pulp obtained is placed in contact a first time (at time t=0 min) at a temperature of 80° C. with the aqueous hydrogen peroxide solution containing 49.5% by weight of H₂O₂ in a proportion of 60 kg H₂O₂/tonne of dry pulp (i.e. per tonne of solids in the pulp). The mixture is left to react for 20 minutes. The pulp is placed in contact a second time (at time t=20 min) at a temperature of 80° C. with the hydrogen peroxide solution in a proportion of 20 kg H₂O₂/tonne of dry pulp. The mixture is left to react for 20 minutes. The pulp is placed in contact a third time (at time t=40 min) at a temperature of 80° C. with the hydrogen peroxide solution in a proportion of 20 kg H₂O₂/tonne of dry pulp. The mixture is left to react for 20 minutes. The pulp is placed in contact a fourth time (at time t=60 min) at a temperature of 80° C. with the hydrogen peroxide solution in a proportion of 20 kg H₂O₂/tonne of dry pulp. The mixture is left to react for 30 minutes. The pulp is drained and separated by pressing and then washed a first time with pure acetic acid and a second time with water. The kappa index of the pulp obtained is equal to 14.3, measured according to standard ISO 302.

### Example 2.1.2 (Comparative)

As in Example 2.1.1, 75 g of the lignocellulose pulp are placed in contact at room temperature (20° C.) with a solution containing 49.50 g of pure formic acid, 90.75 g of pure acetic acid and 24.75 g of distilled water, in a plastic bag, which is then sealed. Manual shaking (blending) is performed for 2 minutes.

The pulp obtained is placed in contact at a temperature of 80° C. with the hydrogen peroxide solution containing 49.5% by weight of H₂O₂ in a proportion of 120 kg H₂O₂/tonne of dry pulp. This temperature is maintained for 90 minutes. The pulp is drained and separated by pressing and then washed a first time with pure acetic acid and a second time with water. The kappa index of the pulp obtained is equal to 15.1, measured according to standard ISO 302.

### Example 2.1.3 (Comparative)

As in Example 2.1.1, 75 g of the lignocellulose pulp are placed in contact at room temperature (20° C.) with a solution containing 49.50 g of pure formic acid, 90.75 g of pure acetic acid and 24.75 g of distilled water, in a plastic bag, which is then sealed. Manual shaking (blending) is performed for 2 minutes.

The pulp obtained is placed in contact a first time (at time t=0 min) at a temperature of 80° C. with the hydrogen peroxide solution containing 49.5% by weight of H₂O₂ in a proportion of 20 kg H₂O₂/tonne of dry pulp. The mixture is left to react for 12 minutes. This operation is repeated 6 times in total (at times t=0, 12, 24, 36, 48 and 60 minutes) at the same temperature and with the same amount of hydrogen peroxide, except that after the sixth and final placing in contact (at t=60 minutes), the reaction is left to proceed for 30 minutes instead of 12 minutes. The pulp is drained and separated by pressing and then washed a first time with pure acetic acid and a second time with water. The kappa index of the pulp obtained is equal to 15.7, measured according to standard ISO 302.

### Example 2.1.4 (Comparative)

As in Example 2.1.1, 75 g of the lignocellulose pulp are placed in contact at room temperature (20° C.) with a solution containing 49.50 g of pure formic acid, 90.75 g of pure acetic acid and 24.75 g of distilled water, in a plastic bag, which is then sealed. Manual shaking (blending) is performed for 2 minutes.

The pulp obtained is placed in contact a first time (at time t=0 min) at a temperature of 80° C. with the hydrogen peroxide solution containing 49.5% by weight of H₂O₂ in a proportion of 60 kg H₂O₂/tonne of dry pulp. The mixture is left to react for 45 minutes. The operation is repeated twice in total (at time t=0 and t=45 minutes) at the same temperature, with the same amount of hydrogen peroxide and the same retention time. The pulp is drained and separated by pressing and then washed a first time with pure acetic acid and a second time with water. The kappa index of the pulp obtained is equal to 15.0, measured according to standard ISO 302.

### Series 2

A lignocellulose pulp prepared as indicated above, containing 40% dryness, with a kappa index equal to 31.4, measured according to standard ISO 302, is used.

### Example 2.2.1 (In Accordance With the Invention)

As in Example 2.1.1, 75 g of the lignocellulose pulp are placed in contact at room temperature (20° C.) with a solution containing 49.50 g of pure formic acid, 90.75 g of pure acetic acid and 24.75 g of distilled water, in a plastic bag, which is then sealed. Manual shaking (blending) is performed for 2 minutes.

The pulp obtained is placed in contact a first time (at time t=0 min) at a temperature of 80° C. with the aqueous hydrogen peroxide solution containing 49.5% by weight of H₂O₂ in a proportion of 80 kg H₂O₂/tonne of dry pulp. The mixture is left to react for 20 minutes. The pulp is placed in contact a second time (at time t=20 min) at a temperature of 80° C. with the hydrogen peroxide solution in a proportion of 80/3 (i.e. about 26.7) kg H₂O₂/tonne of dry pulp. The mixture is left to react for 20 minutes. The pulp is placed in contact a third time (at time t=40 min) at a temperature of 80° C. with the hydrogen peroxide solution in a proportion of 80/3 kg H₂O₂/tonne of dry pulp. The mixture is left to react for 20 minutes. The pulp is placed in contact a fourth time (at time t=60 min) at a temperature of 80° C. with the hydrogen peroxide solution in a proportion of 80/3 kg H₂O₂/tonne of dry pulp. The mixture is left to react for 30 minutes. The pulp is drained and separated by pressing and then washed a first time with pure acetic acid and a second time with water. The kappa index of the pulp obtained is equal to 6.8, measured according to standard ISO 302.

### Example 2.2.2 (Comparative)

As in Example 2.1.1, 75 g of the lignocellulose pulp are placed in contact at room temperature (20° C.) with a solution containing 49.50 g of pure formic acid, 90.75 g of pure acetic acid and 24.75 g of distilled water, in a plastic bag, which is then sealed. Manual shaking (blending) is performed for 2 minutes.

The pulp obtained is placed in contact at a temperature of 80° C. with the hydrogen peroxide solution containing 49.5% by weight of H₂O₂ in a proportion of 160 kg H₂O₂/tonne of dry pulp. This temperature is maintained for 90 minutes. The pulp is drained and separated by pressing and then washed a first time with pure acetic acid and a second time with water. The kappa index of the pulp obtained is equal to 7.2, measured according to standard ISO 302.

### Series 3

A lignocellulose pulp prepared as indicated above, containing 40% dryness, with a kappa index equal to 31.4, measured according to standard ISO 302, is used.

### Example 2.3.1 (In Accordance With the Invention)

As in Example 2.1.1, 75 g of the lignocellulose pulp are placed in contact at room temperature (20° C.) with a solution containing 49.50 g of pure formic acid, 90.75 g of pure acetic acid and 24.75 g of distilled water, in a plastic bag, which is then sealed. Manual shaking (blending) is performed for 2 minutes.

The pulp obtained is placed in contact a first time (at time t=0 min) at a temperature of 80° C. with the hydrogen peroxide solution containing 49.5% by weight of H₂O₂ in a proportion of 50 kg H₂O₂/tonne of dry pulp. The mixture is left to react for 20 minutes. The pulp is placed in contact a second time (at time t=20 min) at a temperature of 80° C. with the hydrogen peroxide solution in a proportion of 50/3 (i.e. about 16.7) kg H₂O₂/tonne of dry pulp. The mixture is left to react for 20 minutes. The raw pulp is placed in contact a third time (at time t=40 min) at a temperature of 80° C. with the hydrogen peroxide solution in a proportion of 50/3 kg H₂O₂/tonne of dry pulp. The mixture is left to react for 20 minutes. The raw pulp is placed in contact a fourth time (at time t=60 min) at a temperature of 80° C. with the hydrogen peroxide solution in a proportion of 50/3 kg H₂O₂/tonne of dry pulp. The mixture is left to react for 30 minutes. The pulp is drained and separated by pressing and then washed a first time with pure acetic acid and a second time with water. The kappa index of the pulp obtained is equal to 12.0, measured according to standard ISO 302.

### Example 2.3.2 (Comparative)

The process is performed as in Example 2.1.2, except that the amount of hydrogen peroxide used for the delignification is 100 kg H₂O₂/tonne of dry pulp instead of 120 kg H₂O₂/tonne. The kappa index of the pulp obtained is equal to 12.7, measured according to standard ISO 302.

### Results

In each series, it is observed that the use of the invention makes it possible to reduce the final kappa index value of the pulp by substantially 5% relative to the final kappa indices obtained in the comparative examples, which demonstrates the efficacy of using the composition according to the invention for the delignification of plant matter or lignocellulose pulp.

Similar results are obtained with rice straw.

1. System for delignifying plant matter impregnated with a solution of organic acid chosen from acetic acid, formic acid, propionic acid, butyric acid, or a mixture of these acids, containing said plant matter and a hydrogen peroxide composition comprising hydrogen peroxide and at least one phosphorus additive, the phosphorus content of the composition being greater than or equal to 40 ppm, expressed as weight of elemental phosphorus relative to the total weight of the composition, for the delignification of plant matter impregnated with a solution of organic acid chosen from acetic acid, formic acid, propionic acid, butyric acid, or a mixture of these acids, said plant matter being chosen from straw and/or wood or a lignocellulose pulp derived from straw and/or wood; the mass ratio of the organic acid solution, expressed as weight of solution, to the plant matter, expressed as weight of solids, being from 1.5:1 to 10:1.

2. System as claimed in claim 1, in which the phosphorus content is greater than or equal to 45 ppm, expressed as weight of elemental phosphorus relative to the total total weight of the composition.

3. System as claimed in claim 1, in which the content of phosphorus additive(s) ranges from 120 ppm to 50 000 ppm, expressed as weight of phosphorus additives additives relative to the total weight of the composition.

4. System as claimed in claim 1, in which the phosphorus additive(s) are chosen from: phosphoric acid, aminophosphonic acids, hydroxyphosphonic acids, diphosphoric acids, orthophosphoric acid, salts thereof and mixtures thereof.

5. System as claimed in claim 1, in which the hydrogen peroxide composition comprises from 30% to 75%, by weight of hydrogen peroxide relative to the total weight of said composition.

6. System as claimed in claim 1, in which the composition is divided into at least two fractions the hydrogen peroxide mass of the first fraction being greater than the hydrogen peroxide mass of the second fraction, for the delignification of impregnated plant matter by placing said impregnated plant matter in contact consecutively with the at least two fractions.

7. A method comprising using the system as claimed in claim 1, for the delignification of impregnated plant matter and for bleaching said delignified plant matter.

8. The method as claimed in claim 7, in which the hydrogen peroxide composition is divided into at least two fractions, the hydrogen peroxide mass of a first fraction being greater than the hydrogen peroxide mass of a second fraction, for delignifying plant matter impregnated with an organic acid solution, said plant matter being chosen from straw and/or wood or a lignocellulose pulp derived from straw and/or wood.

9. The method claimed in claim 8, in which the total amount of hydrogen peroxide introduced via said fractions is from 10 to 300 kg/tonne of impregnated plant matter, expressed as weight of dry pulp.

10. The method claimed in claim 8, in which the composition is divided into at least three fractions, the hydrogen peroxide mass of the first fraction being greater than the respective hydrogen peroxide mass of the second fraction and a third fraction.

11. The method claimed in claim 8, for which the composition is divided into at least three fractions of the hydrogen peroxide composition, the hydrogen peroxide mass of the second fraction being substantially equal to the hydrogen peroxide mass of a third fraction.

12. The method claimed in claim 11, for which the hydrogen peroxide mass of the second fraction is substantially equal to the hydrogen peroxide mass of any other fraction of the hydrogen peroxide composition placed in contact with the impregnated plant matter subsequent to the second fraction.

13. The method claimed in claim 8, for which the hydrogen peroxide mass of the first fraction is greater than or equal to 20% by weight, of the total hydrogen peroxide mass of the composition placed in contact with the impregnated plant matter.

14. The method claimed in claim 8, in which each fraction of the hydrogen peroxide composition is placed in contact with the impregnated plant matter for a retention time during which the hydrogen peroxide composition is left to react with the impregnated plant matter.

15. The method claimed in claim 14 , in which the retention time after placing the impregnated plant matter in contact with a last fraction of the hydrogen peroxide composition has a duration strictly longer than any of the previous retention times.

16. The method claimed in claim 7, in which the composition comprising hydrogen peroxide is constituted, as weight percentages relative to the total weight of the composition:
of 30% to 71% of hydrogen peroxide,
of 0 to 10% of one or more additives,
the remainder to 100% of water.
